(19) United States
(12) Patent Application Publication
(10) Pub. No.: US 2021/0080117 A1
(43) Pub. Date: Mar. 18, 2021

(54) GREASE DUCT WASHING SYSTEM

(71) Applicant: Wilbur L. Creech, Coats, NC (US)

(72) Inventor: Wilbur L. Creech, Coats, NC (US)

(21) Appl. No.: 16/570,250

(22) Filed: Sep. 13, 2019

(51) Int. Cl. F24C 15/20; B08B 9/027; B08B 3/08

(52) U.S. Cl. CPC F24C 15/2021; F24F 2221/225; B08B 3/08; B08B 9/027

(57) ABSTRACT

Cleaning grease ductwork, where a fan is utilized in the ductwork, is accomplished with a series of spray nozzles located on the interior of the ductwork which can spray degreaser and H₂O.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a system of washing grease from the inside of ductwork. More specifically, it relates to a manual or automated degreasing system designed for use with exhaust hoods in restaurants or other grease producing facilities.

### Description of Related Art

All restaurants and many other facilities require an exhaust system to deal with grease laden fumes. Typically, there is an exhaust hood positioned over the cooking surfaces with ducting that goes from the hood usually terminating on the roof of the restaurant. At the end of the ductwork, is a motorized fan which creates an updraft in the hood, pulling all the fumes up through the ductwork, and out of the fan located on the roof.

Unfortunately, much of the grease precipitates out of the fumes and lands on the interior surface of the ductwork. This can create a fire hazard if there is a high enough accumulation. This problem is at least partially solved by hiring a duct cleaning company which degreases the ductwork by hand. While this is effective, it is time consuming and so expensive that most restaurants only clean the duct work every few months. The risks are high that a fire will start in-between cleanings.

### BRIEF SUMMARY OF THE INVENTION

The present invention relates to the discovery that if the interior of an exhaust hood ducting system having an exhaust fan is fitted with spray nozzles and degreaser, with water spraying on the inside of the duct on a regular basis (in one embodiment, 1 to 3 times daily), the duct remains relatively clean and the chance of grease fires is almost eliminated in the ductworks.

Accordingly, in one embodiment, there is a system for cleaning grease from the interior of an exhaust hood ducting system having an exhaust fan comprising:
a) a water supply;
b) a degreaser designed to be mixed with the water supply;
c) a pump to feed the degreaser to the water supply to be mixed;
d) a timer which controls the beginning and end of a cleaning cycle;
e) a plurality of spray nozzles positioned along the interior of the ducting system wherein the mixed degreaser and water are connected to the plurality of spray nozzles wherein the pump causes the mixed degreaser and water to spray from the spray nozzles; and
f) a controller designed to set the cleaning parameters.

In another embodiment, there is a method of cleaning grease from the interior of an exhaust hood ducting system having an exhaust fan comprising:
a) positioning a plurality of spray nozzles along the interior of the ducting system;
b) connecting a feed line with an automatic controller positioned to feed the mixed degreaser and water to the plurality of spray nozzles; and
c) turning the feed on while the exhaust fan is operating.

### BRIEF DESCRIPTION OF THE DRAWINGS

FIG. 1 is a perspective side view of the cleaning system of the invention.

FIG. 2 is a side view of an example of a spray nozzle.

FIG. 3 is a flow chart of the method of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “cleaning grease” refers to removing accumulated oils, solid shortenings, and the like which accumulate on the interior of a hooded ventilation system. In one embodiment, the ventilation system is in a restaurant. Grease is carried into the air, removed via the fan hood, and becomes deposited along the length of the duct.

As used herein, the term “interior” refers to the interior of the duct system where air flows from the hooded fan and where grease accumulates in such a system.

As used herein, the term “exhaust hood ducting system” refers to an exhaust hood over a cooking area with a duct connected to the exhaust hood, which extends from the exhaust hood to the outside, where an exhaust fan is positioned to draw grease laden air into the exhaust hood, up through the duct system to the outside, via the exhaust fan.

As used herein, the term “water supply” refers to water delivered via a water pipe to the spray nozzles. It is assumed that it is under some pressure such that when a valve is open, the water travels to the spray nozzles. In one embodiment, the water is hot (more than 140° F.) though depending on the degreaser, a wide variety of warm and cool water could be utilized. There is a valve on the water pipe for starting and stopping water flow. In one embodiment, it is a ball valve. In another, the valve is controllable via the controller.

As used herein, the term “degreaser” refers to a chemical, which when mixed with water from the water pipe, can be sprayed on the interior of the duct to dissolve and remove the accumulated grease in the duct. Examples of degreasers are SC5EF Cleaner & Degreaser Biodegradable and the like. A valve is on the degreaser so that the controller can open and close the valve and release degreaser to be pumped to the water supply and mixed. In one embodiment, the valve is a solenoid valve.

As used herein, the term “pump” refers to a pump connected to the degreaser supply to feed the degreaser to the water supply such that it is mixed. Once mixed, the water pressure from the water and the pump delivers the mixed degreaser and water to the spray nozzles.

As used herein, the term “timer” refers to a timer which can control the beginning and/or the end of the mixed degreaser and water being delivered to the spray nozzles, i.e., the beginning and end of a cleaning cycle.

As used herein, the term “beginning and end of a cleaning cycle” refers to the starting and stopping of the mixed degreaser and water being delivered to the spray nozzles.

As used herein, the term “spray nozzles” refers to a device designed to deliver a spray of the mixed degreaser and water. It is aimed such that the plurality of spray nozzles can essentially spray all points of the interior of the ducting as necessary.

As used herein, the term “controller” refers to an electronic device such as a computer or other such device, which can be programmed to set the cleaning parameters desired, including time. It can also measure the amount of degreaser to let the user know when it's time to add more to the storage. In one embodiment, the cleaning parameters set on the controller can be overridden and those parameters can be manually started and stopped.

As used herein, the term “cleaning parameters” refers to the cleaning activity. So for example, the time and duration the system is run, the pressure it is run at, the number of spray nozzles to be activated, activation of the pump, and the like, are all parameters.

As used herein, the term “access door” refers to a door in the ducting of the system positioned to give access to the spray nozzles for cleaning, replacement aiming, and the like. The door can be simple and be hinged or removable, as desired.

### DRAWINGS

Now referring to the drawings, FIG. 1 is a perspective side view of the system of the present invention. In this view, and exhaust hood 1 is connected to an exhaust duct 2 which terminates on the outside at exhaust fan 3. The cleaning system 4 is shown comprising a degreaser 5a in a container 5. The degreaser 5a is pumped using feed pump 6 and is controlled by controller 8. The degreaser pipe 17 terminates at the water supply pipe 10, wherein the two are mixed. There is a timer 9 shown separate from the controller but in some embodiments, the timer is built into the controller. A water supply pipe 10 is positioned to join with the degreaser and can have one or more valves. In this view, there is a ball valve 11 and a solenoid valve 12 which are controlled by the controller.

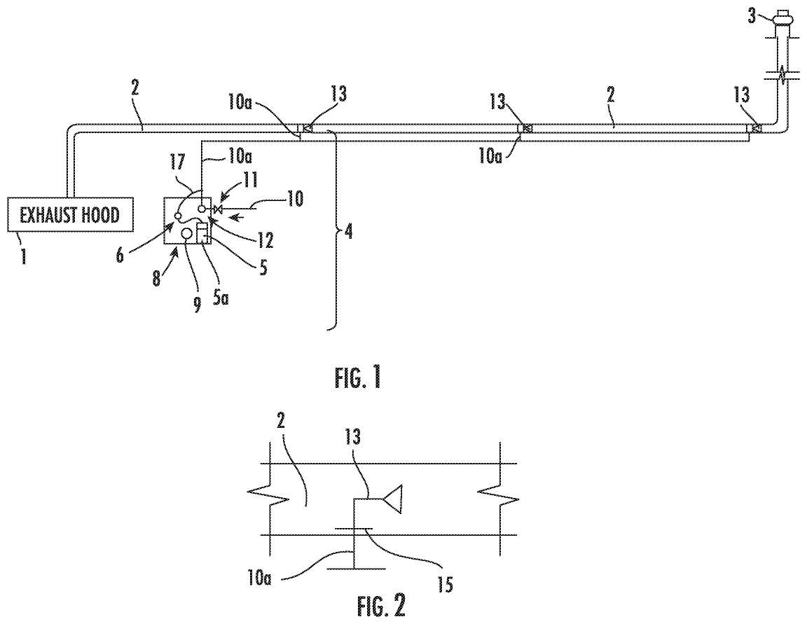

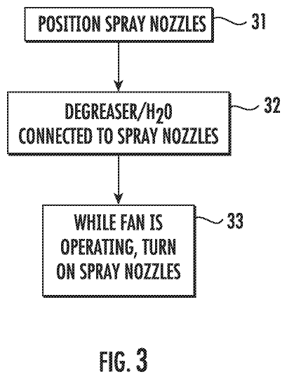

Once the degreaser and water are mixed, at any point after that it will consist of degreaser and water at pipe feed 10a and beyond. The degreaser/water pipe feed 10a delivers the mixture to spray nozzles 13. When the controller is operated, the mixed degreaser and water is sprayed for a time or manually operated as necessary. In one embodiment, each spray nozzle can independently be controlled by the controller. In order for a user to access spray nozzles 13, there is an access door 15 which can be opened for such access. FIG. 2 is a close up of a portion of ducting 2, the degreaser, water supply 10a, spray nozzles 13, and the access door 15.

FIG. 3 is a flow chart of the method of the present invention. Spray nozzles are positioned 31 in the ducting for cleaning the interior of the ducting. A degreaser/water supply which is connected to the spray nozzles 32 delivers the solution to the spray nozzles for cleaning. The spray activity however, has the caveat that the exhaust fan must be operating during cleaning 33.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A system for cleaning grease from the interior of an exhaust hood ducting system having an exhaust fan comprising:
a) a water supply;
b) a degreaser designed to be mixed with the water supply;
c) a pump to feed the degreaser to the water supply to be mixed;
d) a timer which controls the beginning and end of a cleaning cycle;
e) a plurality of spray nozzles positioned along the interior of the ducting system wherein the mixed degreaser and water are connected to the plurality of spray nozzles wherein the pump causes the mixed degreaser and water to spray from the spray nozzles; and
f) a controller designed to set the cleaning parameters.

2. The system for cleaning according to claim 1 wherein the degreaser is stored in a tank connected to the pump.

3. The system for cleaning according to claim 1 wherein there is a solenoid valve connected to the degreaser wherein the controller can open and close the solenoid valve to deliver degreaser to be mixed with the water.

4. The system for cleaning according to claim 1 wherein there is a ball valve connected to the water supply wherein the controller can open and close the ball valve to deliver water to be mixed with the degreaser and delivered to the spray nozzles.

5. The system for cleaning according to claim 1 wherein the water is at least about 140° F. water.

6. The system for cleaning according to claim 1 wherein there is an access door in the ducting system to give access to the spray nozzles.

7. The system for cleaning according to claim 1 wherein the controller can be overridden and the system can be started and stopped manually.

8. The system for cleaning according to claim 1 wherein the system of cleaning is set on the controller to run for between 5 and 90 seconds, 1 to 5 times a day.

9. The system for cleaning according to claim 1 wherein the controller only allows operation of the system for cleaning when the exhaust fan is actively engaged.

10. A method of cleaning grease from the interior of an exhaust hood ducting system having an exhaust fan comprising:
a) positioning a plurality of spray nozzles along the interior of the ducting system;
b) connecting a feed line with an automatic controller positioned to feed the mixed degreaser and water to the plurality of spray nozzles; and
c) turning the feed on while the exhaust fan is operating.

11. The method of cleaning according to claim 10 wherein the feed is turned on at least once a day.

12. The method of cleaning according to claim 10 wherein the feed is turned on for between 10 seconds and about 60 seconds.
